(19) United States
(12) Patent Application Publication
(10) Pub. No.: US 2022/0227036 A1
(43) Pub. Date: Jul. 21, 2022

(54) METHOD FOR MANUFACTURING CONTAINER HAVING COVERING LAYER AND MOLDING MOLD

(71) Applicant: TOYO SEIKAN CO., LTD., Tokyo (JP)

(72) Inventors: Hiromitsu KIYOTO, Yokohama-shi, Kanagawa (JP); Souya YOSHIDA, Yokohama-shi, Kanagawa (JP); Masashi FUJIOKA, Yokohama-shi, Kanagawa (JP)

(73) Assignee: TOYO SEIKAN CO., LTD., Tokyo (JP)

(21) Appl. No.: 17/608,574

(22) PCT Filed: Apr. 3, 2020
(86) PCT No.: PCT/JP2020/015330

§ 371 Date: Nov. 3, 2021

(30) Foreign Application Priority Data
Jul. 12, 2019 (JP) 2019-130297

(51) Int. Cl. B29C 49/50; B29C 49/22

(52) U.S. Cl. CPC B29C 49/50; B29L 2031/7158; B29C 2949/3034; B29C 49/22

(57) ABSTRACT

A method for manufacturing a container (100) having a covering layer includes: acquiring a preform (200) having a preform covering layer (204) formed by using a synthetic resin having thermoplasticity, the preform being a material for forming a container (100) having a covering layer (104) manufactured by blow molding; setting the preform (200) in a blow mold (310) wherein a blade (440) is provided to a portion of a surface of the blow mold (310) with where the container is brought into contact, the blade having a height that corresponds to a thickness of the covering layer (104); and forming the container (100) having the covering layer (104) by performing blow molding on the preform (200), the covering layer having a slit (190) formed by the blade (440).

### TECHNICAL FIELD

The invention relates to a method for manufacturing a container having a covering layer and to a molding mold.

### BACKGROUND ART

There is a known container made of a synthetic resin, the container being manufactured in such a manner that a preform is formed by using a synthetic resin, such as polyethylene terephthalate, and this preform is molded into a bottle shape by stretch blow molding or the like. The containers made of a synthetic resin are used as beverage containers that contain various beverages, for example.

There are known composite containers where the periphery of the container is covered by a covering layer so as to allow such containers to have various functions or characteristics. For example, Patent Literature 1 discloses a composite container and a method for manufacturing the composite container. In the disclosed manufacturing method, first, a preform made of a plastic material is prepared. Then, a plastic member is provided to surround the outer side of this preform, and the preform and the plastic member are brought into close contact with each other to prepare a composite preform. Next, blow molding is performed on the composite preform in a blow mold to cause the preform and the plastic member of the composite preform to inflate as an integral body. The composite container where the plastic member is provided to the periphery of a container body is manufactured in this manner.

In the composite container disclosed in Patent Literature 1, to allow the plastic member to be easily peeled and removed from the container body when the container is discarded, perforated openings are formed in the plastic member. These perforated openings facilitate cutting of the plastic member. These openings are formed in such a manner that openings are formed in the plastic member of the composite preform and, thereafter, blow molding is performed on the composite preform.

### PRIOR ART DOCUMENT

### Patent Literature

Patent Literature 1: JP 2016-55524 A

### SUMMARY OF INVENTION

It is an object of the invention to provide a method for manufacturing a container having a covering layer with a slit formed at a portion of the covering layer.

One aspect of the invention is directed to a method for manufacturing a container having a covering layer, the method including: acquiring a preform having a preform covering layer formed by using a synthetic resin having thermoplasticity, the preform being a material for forming a container having a covering layer manufactured by blow molding; setting the preform in a blow mold wherein a blade is provided to a portion of a surface of the blow mold with where the container is brought into contact, the blade having a height that corresponds to a thickness of the covering layer; and forming the container having the covering layer by performing blow molding on the preform, the covering layer having a slit formed by the blade.

Another aspect of the invention is directed to a molding mold used in blow molding for a container, the molding mold including: a first barrel mold and a second barrel mold configured to form a shape of a body of the container; a bottom mold configured to form a shape of a bottom portion of the container; and a neck insert configured to form a shape of a neck portion of the container, wherein the neck insert has a neck portion contact surface and a neck ring contact surface, the neck portion contact surface being brought into contact with the neck portion, the neck ring contact surface being brought into contact with a neck ring of the container, and the neck insert includes a blade extending from the neck portion contact surface to the neck ring contact surface.

According to the invention, it is possible to provide a method for manufacturing a container having a covering layer with a slit formed at a portion of the covering layer.

### BRIEF DESCRIPTION OF DRAWINGS

FIG. 1A is a cross-sectional view schematically showing a constitutional example of a container according to one embodiment.

FIG. 1B is a perspective view schematically showing a constitutional example of an area around a neck portion of the container according to the embodiment.

FIG. 2 is a cross-sectional view schematically showing a constitutional example of a preform according to the embodiment.

FIG. 3 is a view for describing one example of blow molding according to the embodiment.

FIG. 4 is a view schematically showing one example of the locus of the movement of a mold used in blow molding according to the embodiment when the mold is closed and opened.

FIG. 5A is a perspective view schematically showing a constitutional example of neck inserts according to the embodiment.

FIG. 5B is a plan view schematically showing a constitutional example of the neck inserts according to the embodiment.

FIG. 5C is a front view schematically showing a constitutional example of a first neck insert according to the embodiment.

FIG. 5D is an enlarged perspective view schematically showing a constitutional example of center portions of the neck inserts according to the embodiment.

FIG. 5E is an enlarged view schematically showing a constitutional example of an area in the vicinity of blades of the neck insert according to the embodiment.

FIG. 5F is an enlarged view schematically showing a constitutional example of an area in the vicinity of the blade of the neck insert according to the embodiment.

### DESCRIPTION OF EMBODIMENT

One embodiment of the invention will be described with reference to drawings. This embodiment relates to a container made of a synthetic resin. This embodiment particularly relates to a method for manufacturing a container made of a synthetic resin. The container made of a synthetic resin according to this embodiment is a composite container having a multilayered structure. In the composite container, a covering layer has slits at a portion thereof to facilitate peeling of the covering layer when the composite container is discarded.

### [Container]

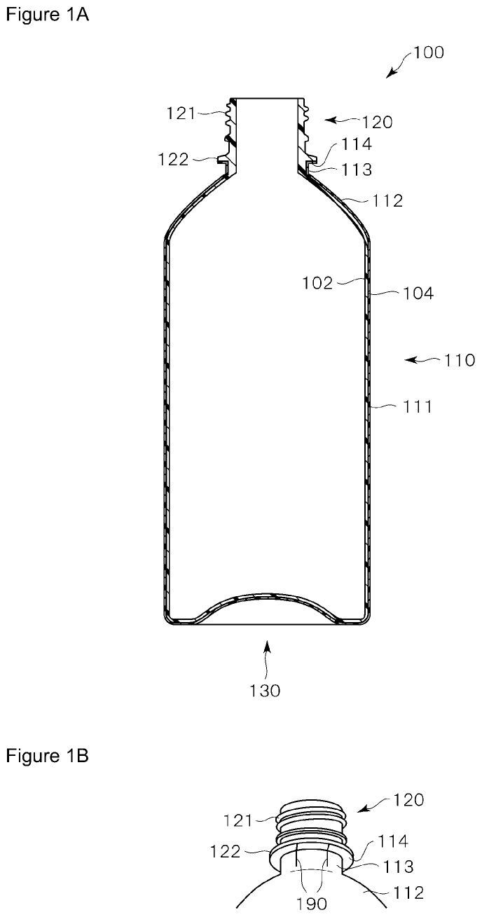

FIG. 1A is a longitudinal cross-sectional view schematically showing a configuration example of a container 100 according to this embodiment. In the drawing, the detailed shape for the design or the function of the container 100 is omitted, and only the outline shape of the container 100 is illustrated. In an example shown in FIG. 1A, the container 100 is a bottomed bottle having a substantially cylindrical shape with a mouth at one end thereof. That is, as shown in FIG. 1A, the container 100 includes a body 110 and a mouth portion 120 having a smaller diameter than the body 110, contents being stored in the body 110, contents being taken into and out from the container 100 through the mouth portion 120. The end portion of the container 100 on the side opposite to the mouth portion 120 is closed into a bottom portion 130. The body 110 includes a barrel portion 111, a shoulder portion 112, and a neck portion 113, the barrel portion 111 having a substantially cylindrical shape, the shoulder portion 112 having a substantially truncated cone shape that gradually reduces a diameter from the barrel portion 111 toward the mouth portion, the neck portion 113 having a substantially cylindrical shape that connects the upper end of the shoulder portion 112 and the mouth portion 120. A screw thread 121 is formed on the mouth portion 120 to allow attachment of a cap not shown in the drawing. A neck ring 122 having an annular shape is provided on a boundary between the mouth portion 120 and the body 110 along the circumferential direction, the neck ring 122 protruding outward in the radial direction.

The body 110, the mouth portion 120, and the bottom portion 130 of the container 100 are formed of a container body 102 as an integral body. The container 100 includes a covering layer 104 that covers the container body 102 on the body 110 and the bottom portion 130. As described above, the container 100 is a composite container having the covering layer. In this embodiment, the covering layer 104 covers the container body 102 from the bottom portion 130 to a lower surface 114 of the neck ring 122 through the barrel portion 111, the shoulder portion 112 and the neck portion 113 of the body 110.

The container body 102 is made of a thermoplastic resin. The container body 102 is formed by using an ethylene terephthalate-based thermoplastic polyester resin, such as polyethylene terephthalate, for example. The thermoplastic polyester resin is not limited to polyethylene terephthalate, and polybutylene terephthalate, polyethylene naphthalate, amorphous polyarylate, polylactic acid, polyethylene furanoate, copolymers thereof or the like may also be used. A mixture of these resins, a mixture of these resins and another resin or the like may also be used. Further, polycarbonate, an acrylonitrile resin, polypropylene, propylene-ethylene copolymer, polyethylene, or the like may also be used.

The covering layer 104 is also made of a thermoplastic resin. It is preferable that the covering layer 104 be formed by using a thermoplastic resin that is immiscible with a thermoplastic resin used for forming the container body 102. By using a thermoplastic resin that is immiscible with a thermoplastic resin used for forming the container body 102, the covering layer 104 can be easily peeled from the container body 102. Such a configuration facilitates recycling of the container 100. In the case where ethylene terephthalate-based thermoplastic polyester is used for forming the container body 102, it is preferable that a polyolefin-based resin, such as polyethylene or polypropylene, or ethylene-vinyl alcohol copolymer, or a polyamide-based resin, such as poly-meta-xylylene adipamide (MXD6), for example, be used for forming the covering layer 104.

The covering layer 104 may be colored, decorated, or caused to have various functions. For example, a pigment, a colorant, or the like may be added to color the covering layer 104. The covering layer 104 may have light-shielding property, for example. The container body 102 and the covering layer 104 can be easily separated and hence, recyclability of the colorless transparent container body 102 is maintained regardless of the colored covering layer 104.

FIG. 1B is a perspective view of the neck ring 122 shown in FIG. 1A as viewed from below. As shown in the drawing, in the container 100 according to this embodiment, slits 190 are formed at the upper end portion of the covering layer 104. The slits 190 are portions where only the covering layer 104 or only the upper layer of the covering layer 104 is cut with no damage or practically no damage to the container body 102. The slits 190 are portions that form starting points for tearing off the covering layer 104 when the covering layer 104 is separated from the container body 102. Two slits 190 are formed within a range shown in FIG. 1B. Each slit 190 is linearly provided from the edge of the lower surface 114 of the neck ring 122 to the neck portion 113. The slits 190 may also be formed on a side opposite to a portion of the neck portion 113 shown in FIG. 1B in the same manner.

### [Method for Manufacturing Container]

A method for manufacturing the container 100 according to this embodiment will be described. In this embodiment, the container 100 is manufactured by a so-called two-stage method. That is, first, a preform having a bottomed cylindrical shape is prepared by injection molding. Next, the preform is softened by heating. This softened preform is set in a mold, and is molded into a predetermined container shape by biaxially stretching blow molding, for example.

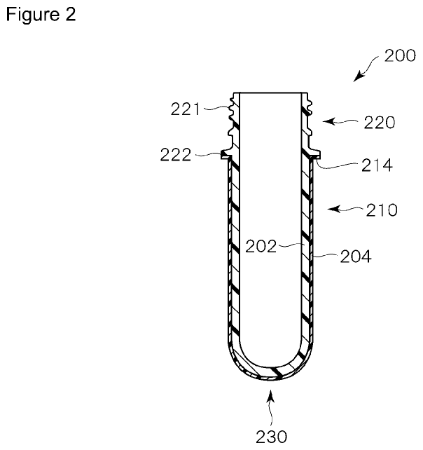

A configuration example of the preform prepared in this embodiment is schematically shown in FIG. 2. A preform 200 prepared in this embodiment has a substantially cylindrical shape with one end open and the other end closed. A mouth portion 220 is formed on the open end of the preform 200. The closed end of the preform 200 is referred to as a bottom portion 230. The bottom portion 230 has a hemispherical shape. A cylindrical portion between the mouth portion 220 and the bottom portion 230 is referred to as a barrel portion 210.

The mouth portion 220 of the preform 200 is not stretched in the blow molding, which is performed in a later stage. Accordingly, the mouth portion 220 of the preform 200 becomes the mouth portion 120 of the container 100 without any change. A screw thread 221 is formed on the outer peripheral surface of the mouth portion 220 of the preform 200 to allow attachment of a cap not shown in the drawing. The screw thread 221 becomes the screw thread 121 of the container 100 without any change. A neck ring 222 is also provided to the barrel-portion-210 side of the mouth portion 220, the neck ring 222 annularly protruding along the circumferential direction. The neck ring 222 becomes the neck ring 122 of the container 100 without any change.

The preform 200 includes a preform body 202 that forms the mouth portion 220, the barrel portion 210, and the bottom portion 230. The preform 200 also includes a preform covering layer 204 that covers the preform body 202 on the barrel portion 210 and the bottom portion 230. The preform covering layer 204 is provided up to the edge portion of a lower surface 214 of the neck ring 222 from the bottom portion 230.

In the blow molding, which is performed in a later stage, the preform body 202 is stretched to form the container body 102 of the container 100, and the preform covering layer 204 is stretched to form the covering layer 104 of the container 100. The preform body 202 and the preform covering layer 204 are integrally stretched.

The preform 200 is prepared by a so-called double injection molding (two-color injection molding) method, for example. The method for preparing the preform 200 is not limited to the double injection molding. Compression molding or the like may be used for the preparation of the preform 200. Further, the preform covering layer 204 may be formed such that a heat shrink material is disposed around the preform body 202 and is heat-shrunk. According to the double injection molding, the preform covering layer 204 can be easily formed such that the preform covering layer 204 covers the entire bottom portion 230 of the preform 200. That is, it is possible to easily form the covering layer 104 that covers the entire bottom portion 130 of the container 100.

The preform 200 is heated, conveyed to a blow molding apparatus, and set in a blow mold. The container 100 is formed by performing blow molding on the heated preform 200. The blow molding apparatus successively performs blow molding on the heated preforms 200, which are successively conveyed, by using a plurality of blow molds. Preforms used as the material for blow molding may be prepared in the same factory. Alternatively, preforms prepared in another factory may be procured as preforms to be used as the material for blow molding. A method for acquiring preforms is not particularly limited.

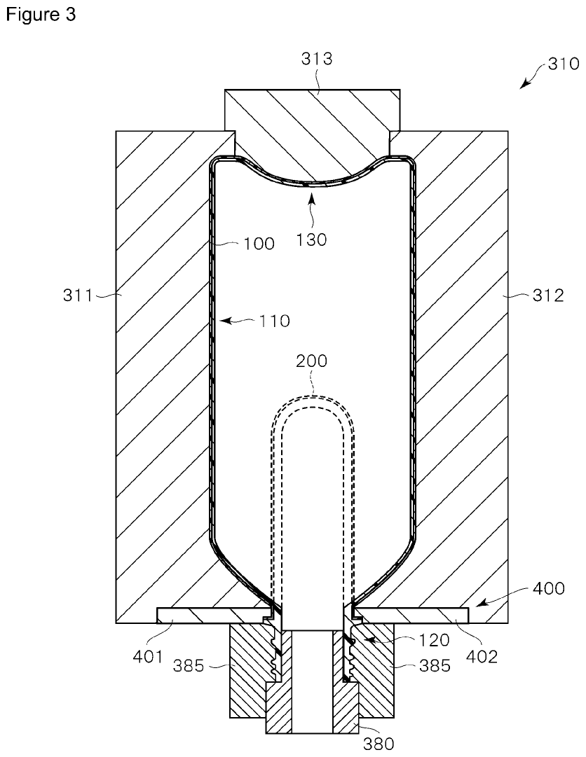

The blow molding will be described with reference to the schematic cross-sectional view shown in FIG. 3. In FIG. 3, broken lines schematically show the shape of the preform 200 before blow molding is performed.

The preform 200 is conveyed in a state of being held by a holder 380. The holder 380 has a substantially cylindrical shape, and is inserted into the mouth portion 220 of the preform 200. In the blow mold, the mouth portion 220 is fixed by a fixing member 385 that surrounds the periphery of the mouth portion 220. Portions of the preform 200 that are closer to the bottom portion 230 than the neck ring 222, such as the barrel portion 210, are disposed in a blow mold 310 having a hollow cavity when the blow mold 310 is closed.

The blow mold 310 includes, for example, a first barrel mold 311 and a second barrel mold 312, a bottom mold 313, and a neck insert 400. The first barrel mold 311 and the second barrel mold 312 mainly form the shape of the body 110 of the container 100. The bottom mold 313 mainly forms the shape of the bottom portion 130 of the container 100. The neck insert 400 forms the shape of the neck portion 113 of the container 100. The neck insert 400 is an insert mold in the first barrel mold 311 and the second barrel mold 312 for forming the neck portion 113. The neck insert 400 includes a first neck insert 401 and a second neck insert 402, the first neck insert 401 being fitted in the first barrel mold 311, the second neck insert 402 being fitted in the second barrel mold 312. The configuration of the blow mold 310 described in this embodiment is merely for the sake of example, and the configuration of the blow mold 310 is not limited to the above.

The preform 200 disposed in the closed blow mold 310 is stretched by using a stretching rod and pressurized air, for example. The preform 200 is stretched in the axial direction by the stretching rod not shown in the drawing, for example, and is stretched in the axial direction and the circumferential direction by pressurized air that is blown into the preform 200. As a result, the container 100 that conforms to the inner surface shape of the blow mold 310 is formed. The preform body 202 and the preform covering layer 204 of the preform 200 are integrally stretched. As a result, the container body 102 and the covering layer 104 that covers the container body 102 are formed. Thereafter, the blow mold 310 is opened to take out the formed container 100.

### [Molding Mold]

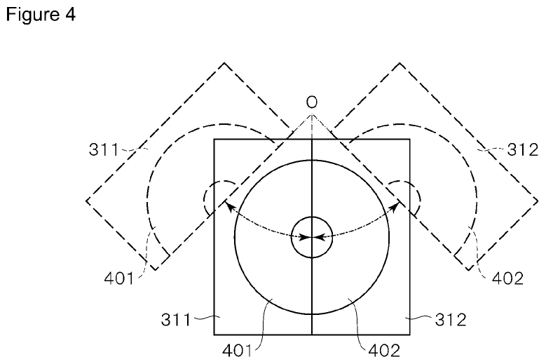

FIG. 4 schematically shows the locus of the movement of the blow mold when the blow mold according to this embodiment is closed and opened. As shown in the drawing, the first barrel mold 311, in which the first neck insert 401 is fitted, and the second barrel mold 312, in which the second neck insert 402 is fitted, move to trace an arc about a movement center O.

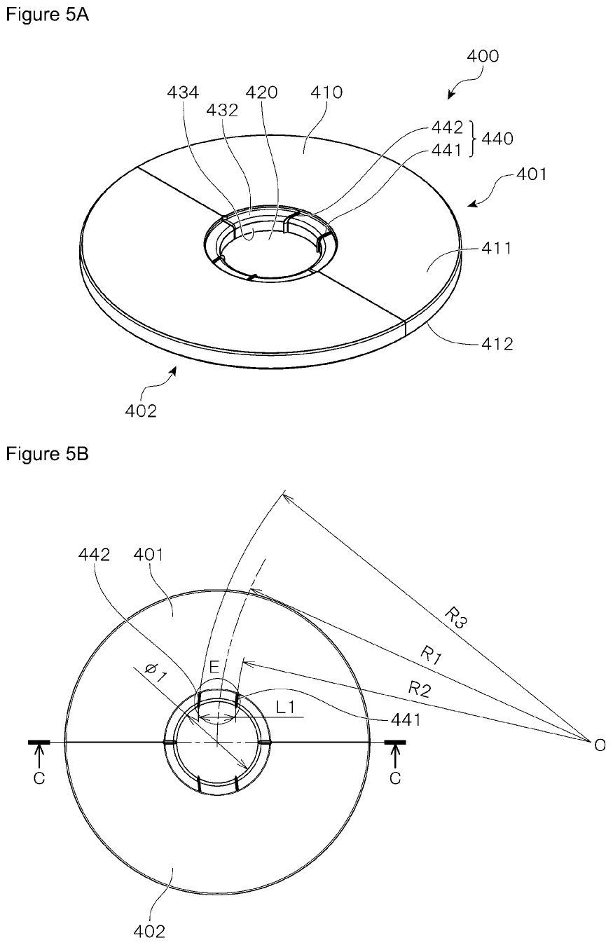

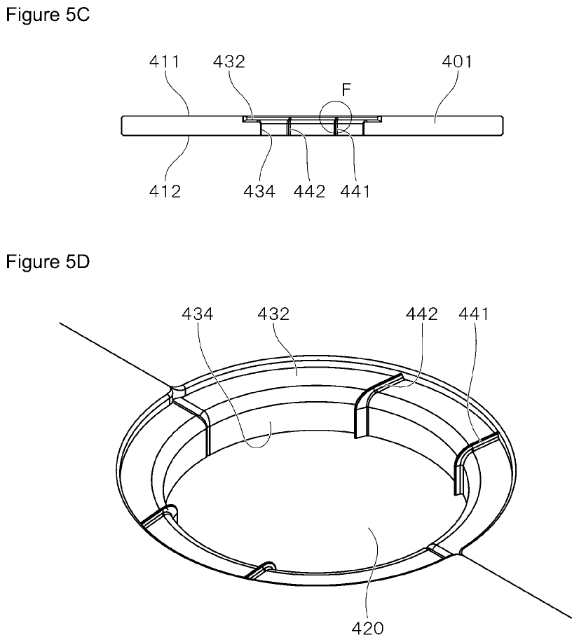

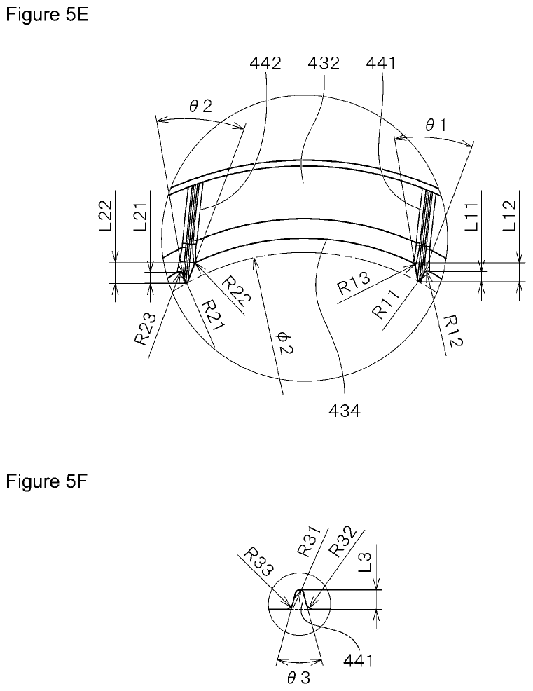

FIG. 5A to FIG. 5F schematically show a configuration example of the neck insert 400 according to this embodiment. FIG. 5A is a perspective view. FIG. 5B is a plan view. FIG. 5C is a view of a plane C-C shown in FIG. 5B, that is, FIG. 5C is a front view of the first neck insert 401. FIG. 5D is an enlarged perspective view of a center portion. FIG. 5E is an enlarged view of a circle portion E shown in FIG. 5B. FIG. 5F is an enlarged view of a circle portion F shown in FIG. 5C.

The first neck insert 401 and the second neck insert 402 have a symmetrical shape with respect to a parting plane. Each of a body 410 of the first neck insert 401 and a body 410 of the second neck insert 402 has a substantially semicircular disc shape having a semi-circular cutout that forms a hole 420 in which the neck portion 113 of the container 100 is fitted. A principal surface of the body 410 which is disposed close to the mouth portion 120 of the container 100 is referred to as a first surface 411, and a principal surface of the body 410 which is disposed close to the bottom portion 130 of the container 100 is referred to as a second surface 412. A recess is formed on the first surface 411 of the body 410 at a position in the vicinity of the cutout forming the hole 420, and the neck ring 122 of the container 100 is fitted in the recess. The portion of the body 410 having such a recess has a smaller thickness than other portions of the body 410. A surface configured to be brought into contact with the lower surface 114 of the neck ring 122 is referred to as a neck ring contact surface 432, and a surface configured to be brought into contact with the neck portion 113 is referred to as a neck portion contact surface 434.

In this embodiment, blades 440 are provided to the neck ring contact surface 432 and the neck portion contact surface 434 of the body 410 so as to form the slits 190. In this embodiment, two blades 440, that is a first blade 441 and a second blade 442, are provided to each of the first neck insert 401 and the second neck insert 402. The height of the blades 440 is substantially equal to the thickness of the covering layer 104 of the container 100. In this embodiment, the neck portion 113 is minimally stretched at the time of performing blow molding and hence, the thickness of the covering layer 104 matches the thickness of the preform covering layer 204 at this portion.

When the first neck insert 401 and the second neck insert 402 hold the neck portion of the preform 200 at the time of performing blow molding, the preform covering layer 204 is cut by the blades 440. As a result, after blow molding is performed, the covering layer 104 of the container 100 has the slits 190 at the neck portion 113.

The height of the blades is not limited to a height that matches the thickness of the covering layer 104. The height of the blades may be slightly lower or higher than the thickness of the covering layer 104 provided that the height of the blades corresponds to the thickness of the covering layer 104. When the height of the blades is slightly lower than the thickness of the covering layer 104, the covering layer 104 is not completely separated by the slits 190 with only grooves being formed on the covering layer 104. Also in this case, the covering layer 104 can be easily broken from the slits 190. When the height of the blades is slightly higher than the thickness of the covering layer 104, slight flaws are formed on the container body 102. However, provided that such flaws cause no problem in practical use, the height of the blades may be slightly higher than the thickness of the covering layer 104.

As described above, when the mold is closed and opened, the first neck insert 401 and the second neck insert 402 move to trace an arc. With such movement of the first neck insert 401 and the second neck insert 402, the blades 440 provided to each of the first neck insert 401 and the second neck insert 402 also move to trace an arc. In view of the above, the blades 440 of this embodiment are provided as described below. That is, the blades 440 protruding from the neck portion contact surface 434 are provided to perpendicularly pierce into the covering layer 104 on the neck portion 113 at the time of closing and opening the mold. Therefore, as shown in FIG. 5B, each blade 440 protruding from the neck portion contact surface 434 protrudes along the arc traced by the locus of the movement of the blade tip about the movement center O, that is, protrudes in a tangential direction at a position on the arc where the blade 440 is attached. Each blade 440 protruding from the neck ring contact surface 432 is provided such that a blade tip moves along a movement path that allows the blade tip to draw a line on the lower surface 114 of the neck ring 122 at the time of closing and opening the mold. Therefore, as shown in FIG. 5B, each blade 440 is provided along the arc traced by the locus of the movement of the blade tip about the movement center O, that is, provided along the tangent line at a position on the arc where the blade 440 is attached. As described above, the blades 440 are disposed along the locus of the movement of the first neck insert 401 and the second neck insert 402. The blades 440 are disposed as described above and hence, there is no possibility of the covering layer 104 being torn due to the movement of the blades 440 when the mold is closed and opened, and the thin slits 190 are formed in the covering layer 104.

One example of the dimensions of the neck insert 400 is shown in FIG. 5B, FIG. 5E, and FIG. 5F. The neck insert 400 shown in FIG. 5B has the hole 420 into which the neck portion 113 of the container 100 is inserted, and a diameter ϕ1 of the hole 420 is 26.2 mm, for example. The blades 440 come into contact with a circle shown in FIG. 5E, and the circle has a diameter ϕ2 of 24.7 mm, for example.

The blade 440 disposed at a position close to the movement center O of the first neck insert 401 and the second neck insert 402 when the mold is closed and opened is taken as the first blade 441, and the blade 440 disposed at a position away from the movement center O is taken as the second blade 442. A distance shown in FIG. 5B from the movement center O to the center of the neck insert 400, that is, a radius R1 of the locus of the center of the neck insert 400 is 120.0 mm, for example. A distance from the movement center O to the first blade 441, that is, a radius R2 of the locus of the first blade 441 is 114.4 mm, for example. A distance from the movement center O to the second blade 442, that is, a radius R3 of the locus of the second blade 442 is 126.4 mm, for example. A distance L1 from the distal end of the first blade 441 to the distal end of the second blade 442 is 12 mm, for example.

As shown in FIG. 5E, regarding the heights of the blade tip of the first blade 441 measured from the neck portion contact surface 434, a height L11 at a position close to the movement center O is 0.53 mm, for example, and a height L12 at a position away from the movement center O is 0.97 mm, for example. As for the heights of the blade tip of the second blade 442 from the neck portion contact surface 434, a height L21 at a position away from the movement center O is 0.57 mm, for example, and a height L22 at a position close to the movement center O is 1.08 mm, for example. As shown in FIG. 5F, a height L3 of the blade tip of the blade 440 from the neck ring contact surface 432 is 0.5 mm, for example.

As shown in FIG. 5E and FIG. 5F, radii of curvature R11, R21, R31 at the distal ends of the blades 440 are 0.1 mm, for example, and blade angles θ1, θ2, θ3 of the blades 440 are 30°, for example. At portions where the blades 440 are connected to the neck portion contact surface 434 or the neck ring contact surface 432, radii of curvature R12, R13, R22, R23, R32, R33 are 0.2 mm, for example.

These dimensions are merely for the sake of example, and may be suitably changed.

In the neck insert 400, for example, Thomson blades may be attached, as replaceable blades 440, to the body 410 of the neck insert 400 formed by cutting, grinding or the like, for example. The blades 440 may also be formed by cutting, grinding, electric discharge machining or the like at the time of forming the body 410 of the neck insert 400. When the blades 440 are formed as bodies separate from the body 410, only the blades 440 can be replaced and hence, ease of maintenance is improved.

According to this embodiment, when the preform 200 is held by the neck insert 400 at the time of performing blow molding, the slits are formed in the preform covering layer 204 by the blades 440 provided to the neck insert 400. As a result, the slits 190 are formed in the covering layer 104 of the container 100 manufactured by blow molding. By forming such slits 190, recyclability of the container 100 is improved. That is, when the container 100 is discarded after the container 100 is used, the covering layer 104 can be easily torn from the slits 190, and the covering layer 104 can be easily separated from the container body 102. As described above, the slits 190 can serve as separation starting points at the time of tearing off the covering layer 104. The covering layer 104 may contribute to the aesthetic appearance of the container as a decorative layer having a three-dimensional design, may contribute to the function, such as light shielding property, of the container, or may apply various added values to the container 100.

According to this embodiment, the slits 190 are formed at the time of performing blow molding and hence, it is possible to easily form the slits 190 at consistent positions on the container 100. According to this embodiment, positioning is performed at the time of performing blow molding and hence, it is not necessary to expend labor on performing positioning again only for forming the slits 190.

### [Modification]

In the above-mentioned embodiment, the two slits 190 are formed side by side on each of the front surface and the back surface. However, the configuration is not limited to the above. The number of slits 190, positions where the slits 190 are formed or the like may be suitably changed.

In the above-mentioned embodiment, continuous slits are shown as the slits 190. However, the slits are not limited to the above. Each slit may be intermittently formed, thus being provided in a so-called perforated manner. In this case, the blade 440 includes blades that are intermittently provided.

The above-mentioned embodiment shows an example where the blades 440 are provided only to a portion of the neck insert 400, and the slits 190 are formed only at a portion of the neck portion 113 of the container 100. However, the configuration is not limited to the above. That is, the neck insert 400 is a blade-equipped mold having the blades 440 in the above-mentioned embodiment. However, the blade-equipped mold is not limited to the neck insert 400. The first barrel mold 311, the second barrel mold 312, the bottom mold 313 and the like may also be blade-equipped molds having blades. For example, a configuration may be adopted where blades are intermittently provided to the first barrel mold 311, the second barrel mold 312, and the like so as to intermittently form slits also on the barrel portion 111 of the container 100 in a so-called perforated manner. Such slits formed in a perforated manner may serve as separation guides when the covering layer 104 is torn. In a case where the blades are provided to the first barrel mold 311, the second barrel mold 312 and the like, the covering layer 104 that is brought into contact with the blades is the covering layer 104 that is stretched by blow molding. Therefore, the height of the blades is determined by taking into account the thickness of the stretched covering layer 104. Also in this case, blades are provided along the locus of the movement of the first barrel mold 311, the second barrel mold 312 and the like to prevent the blades from tearing off the covering layer 104 when the mold is opened.

The above-mentioned embodiment describes an example where the first barrel mold 311 and the first neck insert 401, the second barrel mold 312 and the second neck insert 402, and the like move along arc-shaped loci when the mold is closed and opened. However, the configuration is not limited to the above. These molds may move along other loci, such as a linear locus, for example. Also in such a case, a configuration is adopted where the blades 440 are provided with the directions of the blades 440 matching the locus of the mold, the blades 440 move perpendicularly to the covering layer 104, and the blades 440 are prevented from scratching the covering layer 104 with the movement of the mold.

The invention has been described heretofore with reference to the preferred embodiment. However, the invention is not limited to the above-mentioned embodiment, and it is needless to say that various modifications are conceivable without departing from the scope of the invention.

The contents of the documents described in this Description and the Description of the Japanese application that is the basis of Paris priority of the present application are all incorporated herein.

### REFERENCE SIGNS LIST

100 container
102 container body
104 covering layer
110 body
111 barrel portion
112 shoulder portion
113 neck portion
114 lower surface of neck ring
120 mouth portion
121 screw thread
122 neck ring
130 bottom portion
190 slit
200 preform
202 preform body
204 preform covering layer
210 barrel portion
214 lower surface of neck ring
220 mouth portion
221 screw thread
222 neck ring
230 bottom portion
310 blow mold
311 first barrel mold
312 second barrel mold
313 bottom mold
380 holder
385 fixing member
400 neck insert
401 first neck insert
402 second neck insert
410 body
411 first surface
412 second surface
420 hole
432 neck ring contact surface
434 neck portion contact surface
440 blade
441 first blade
442 second blade

1. A method for manufacturing a container having a covering layer, the method comprising:
acquiring a preform having a preform covering layer formed by using a synthetic resin having thermoplasticity, the preform being a material for forming a container having a covering layer manufactured by blow molding;
setting the preform in a blow mold wherein a blade is provided to a portion of a surface of the blow mold with where the container is brought into contact, the blade having a height that corresponds to a thickness of the covering layer; and
forming the container having the covering layer by performing blow molding on the preform, the covering layer having a slit formed by the blade.

2. The method according to claim 1, wherein the blow mold including a blade-equipped mold is used in the blow molding, the blade-equipped mold being a mold including the blade of molds forming the blow mold, the blade being disposed in the blade-equipped mold along a movement locus on which a tip of the blade moves when the blade-equipped mold closes and opens.

3. The method according to claim 1, wherein the blow mold including a neck insert is used in the blow molding, the neck insert being configured to mold a neck portion of the container, and including the blade configured to form the slit at the neck portion of the container.

4. The method according to claim 1, wherein the blow mold configured such that the blade is attached thereto in a replaceable manner is used in the blow molding.

5. A molding mold used in blow molding for a container, the molding mold comprising:
a first barrel mold and a second barrel mold configured to form a shape of a body of the container;
a bottom mold configured to form a shape of a bottom portion of the container; and
a neck insert configured to form a shape of a neck portion of the container, wherein
the neck insert has a neck portion contact surface and a neck ring contact surface, the neck portion contact surface being brought into contact with the neck portion, the neck ring contact surface being brought into contact with a neck ring of the container, and
the neck insert includes a blade extending from the neck portion contact surface to the neck ring contact surface.

6. A molding mold used in the method for manufacturing a container according to claim 1, the molding mold comprising the blade which is provided to the portion of the surface of the blow mold with where the container is brought into contact, the blade having a height that corresponds to a thickness of the covering layer.
